(19) United States
(12) Patent Application Publication
(10) Pub. No.: US 2002/0163150 A1
(43) Pub. Date: Nov. 7, 2002

(54) Patient carrier with storage

(76) Inventor: William P. Willamson, Kaufmon, TX (US)

Correspondence Address: Joseph F. Long, Suite 200, 2508 Ashley Worth Blvd., Austin, TX, 78738, US

(21) Appl. No.: 09/850,517

(22) Filed: May 7, 2001

(51) Int. Cl. B62B 7/00

(52) U.S. Cl. 280/47.38; 280/47.35

(57) ABSTRACT

A carrier to transport a person in sitting position along with luggage, miscellaneous small articles and, when needed a gas cylinder and a holder to drip feed a patient. The carrier with a manually operable fail safe brake and foot rests that are tilted up and foldable whereby one being transported cannot stand on the foot rests and tip the unit but folds the foot rests to allow standing on the floor. The carrier may be stored in a normal cart space and is suitable for use in hospitals, airports etc.

### BACKGROUND OF THE INVENTION

There are many various types of patient carriers or wheelchairs with only a few having desirable transport storage. Objectives of our present invention include a patient carrier

that meets all standards in the Safe Medical Devices Act

that has a streamlined attractive appearance

that has rotating foot rests to reduce storage space

that has easily installed leg rests

that has a fail safe braking system

that has all plastic easily sanitized surface

that may be easily pushed over minor floor irregularities

that has minimal turning radius

that occupies minimal storage space

that provides for readily useable space for suitcase or similar article transportation

that provides for safe transportation of oxygen bottles

that provides for in use transport of patient “drip tubes”

that is of rugged construction of long lasting material

that may be readily pushed and guided

that protects a patients legs during transport

that meets the Federal Ergonomic Standards

that has advertising space on each side

We have found no other similar vehicles in the prior art that have all these desirable features.

The closest prior art we find is U.S. Pat. No. 5,230,524, issued to Jackson on Jul. 27, 1993. Improvements in our present invention include:

fail safe manually operated wheel brakes

ten degree angled foot rests to prevent a patient from trying to stand and thereby tipping the vehicle

a holder for an oxygen cylinder or flower pots

two holders for drip bags or hanging clothes

greater manuverability over slight obstructions

increased tray and under seat storage space

a quick connect leg rest for orthopedic use

improved sanitation by elimination of seat cushions

simplified assembly by molding in two major pieces that are assembled with six bolts.

### SUMMARY OF THE INVENTION

The invention encompasses an improved patient carrier that may be used equally well in hospitals for transporting patients in a seated position or in an air port or hotel for transporting luggage with people who desire assistance in both walking and/or moving luggage. Unique features include a one piece molded body that is bolted to a one piece base; luggage carrying space, openings for safe transportation of an oxygen cylinder or other matter, a rotating angled foot rest that both prevents a user from standing up on the foot rests and tipping the unit and rotates under the vehicle to shorten the unit for storage in conventional wheelchair or cart storage space; and a fail safe braking system that requires manual pressure continuously to allow movement of the unit.

### BRIEF DESCRIPTION OF THE DRAWINGS

FIG. 1 shows a cut a way side view to show shape and details of construction

FIG. 2 shows a top view

FIG. 3 shows details of construction of the brake on each of the front wheels

FIG. 4 shows one of two foot rests with a pin fastener that is also a removable leg rest holder.

FIG. 5 shows a quick connect removable leg rest

### DETAILED DESCRIPTION OF THE INVENTION

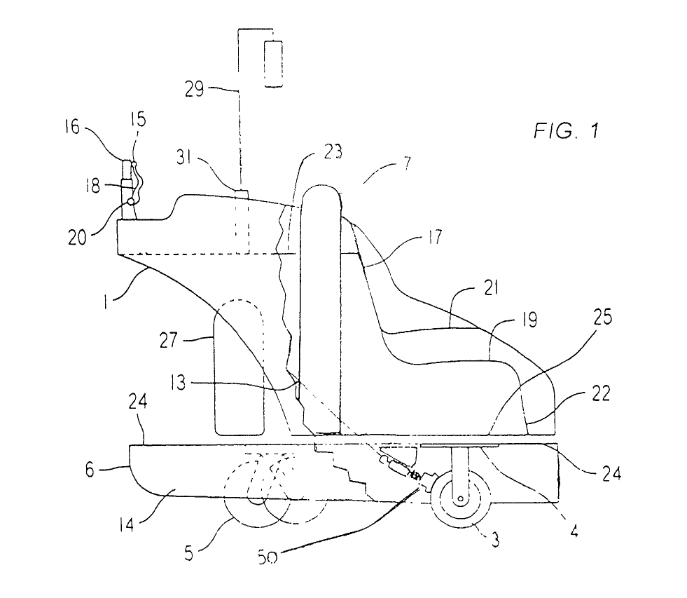

The patent may best be described from the drawings. FIG. 1 shows the overall unit or patient carrier. The unit is rotationally molded in essentially two major pieces.

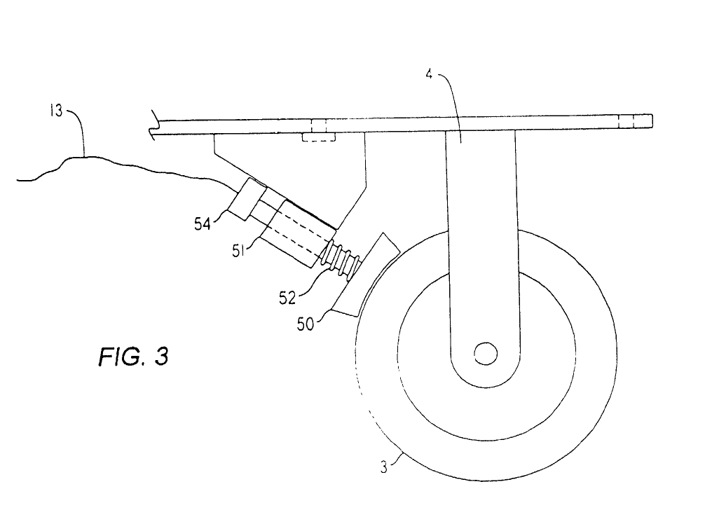

The lower piece or lower platform 6 has a rectangular shape with a flat top 24 and a skirt 14. A pair of fixed front wheels 3 each has base 4 of each wheel bolted to the underside of top 24. Brake shoe 50, shown in more detail in FIG. 3, is spring loaded with adjustable spring 52, FIG. 3 to immobilize the unit until spring loaded lever 15 is manually depressed to actuate connector wire 13 to lift lever 54 to raise the brake shoe from wheels 3. A pair of caster wheels 5 are centrally pivotally attached to the underside of top 24 to allow the unit to have a very short turning radius.

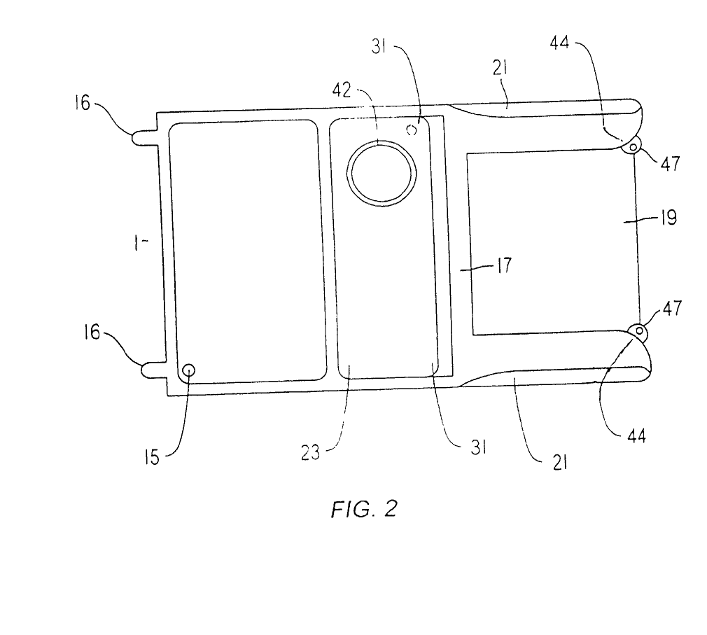

The second major piece is an upper chair like unit 1 that is rotationally molded in one piece and has two sides and integrally molded therein a seat 19, arms 21, a seat back 17, a seat skirt 22, a support base 25, and attached to said seat back, a tray 23 with an opening 42 shown in FIG. 2, a rod support holder 31 and dual push and guide handles 16. Seat cushions have been eliminated as plastic surfaces are easier to maintain clean. Shown in the cut-a-way portion of FIG. 1 is a cylinder 7 as it would be carried in the unit. The opening for the cylinder is also quite useful to carry other objects such as a flower pot. Also shown is a drip support rod 29 for use when needed or is a clothes hanging rod and is normally furnished with the unit and with clips (not shown) on the underside of tray 23 are used to store these rods when necessary. A suitcase 27 is shown to indicate storage space on the lower shelf and under the seat.

The upper major piece of unit 1 may be fastened to the lower piece or unit 6 in any of several ways but preferred fastening is with six bolts. The two piece construction is a major advantage in simplifying assembly of the overall patient carriage.

Dual guide and push handles 16 have one brake lever 15 pivoted at point 20 and spring loaded 18 to hold brake shoes 50 to immobilize the front wheels unless the brake lever 15 is held in the depressed position.

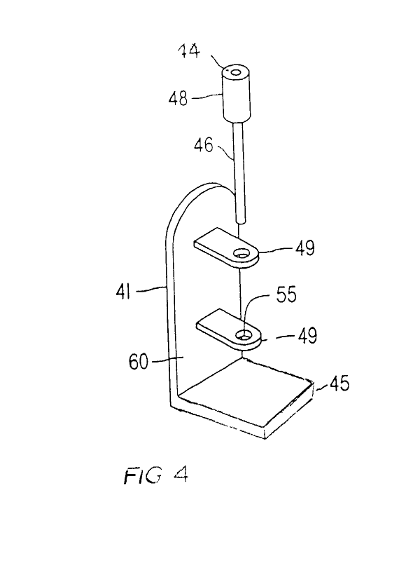

FIG. 2 shows the top view of the patient cart or carrier indicating relative sizes and locations of component parts. The unit 1 may be guided and moved by an attendant by depressing brake lever 15 using vertical handles 16. Drip support holder 31 may be a short segment of aluminum or stainless pipe. Opening 42 may be used to hold a gas cylinder in a safe upright position; most frequent use is for an oxygen cylinder or flower pots. Arms 21 are integrally formed with seat 19 and seat back 17. Openings 44 in dual brackets 47 on each side of the unit hold angled rotatable foot rests as discussed under FIG. 4.

FIG. 3 shows details of the fail safe brakes that are on each front wheel. Brake shoe 50 has a ridged, curved face to fit against wheel 3. Brake spring 52 fits under brake shaft guide 51 which is fastened to the brake assembly bracket. Wire 13 which runs through a normal cable sheath connects lever 54 to spring loaded, manually depressible hand lever 15, FIG. 1, as discussed to lift brake shoe 50 to allow cart movement. If the attendant for some reason fails to depress lever 15 the cart comes to a stop.

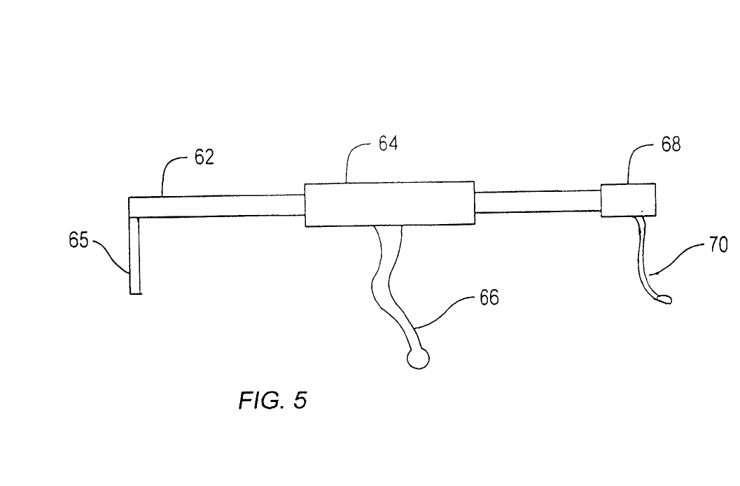

FIG. 4 shows the rotatable angled foot rest unit 41 with the angled footpad 45 and with brackets 49 that slide between brackets 47, FIG. 1 allowing pin 46 with leg rest holder 48 to drop through top opening 44, FIG. 1, through top opening 55 as shown, and through bottom opening 55 as shown. Foot pad 45 is angled upward at 10 degrees to allow resting a foot but to prevent a person in the conveyance from standing thereon. When a person in the conveyance wishes to stand the footpad 45 swings under the seat skirt 22, FIG. 1 and the leg protector 62, FIG. 5, swings back against the seat skirt under seat 19. This arrangement allows a user to step out on a solid floor and also allows shortening the unit for storage.

FIG. 5 shows a removable leg rest device 62 with the cylindrical fastening pin 65 that drops into opening 44, FIG. 4 to removably hold the leg rest device at the proper in use position. A slightly dished leg calf support 64 is equipped with a strap 66 and Velcro™ fasteners and with a dished heel support 68 with heel support strap 70 with similar fasteners.

What is claimed is

1. A manually movable patient carrier with a patient seating means on a forward end, a cargo carrying base below said patient seating means; a fail safe brake means wherein an attendant must depress a lever to allow movement of said carrier; and a means to prevent a patient from tilting said carrier as said patient stands up.

2. A patient carrier comprising:
1) a lower platform with a skirt around said lower platform,
2) a pair of wheels attached one on each side of a beginning end of said lower platform;
3) a pair of wheels attached opposite each other to a central pivot point to a spot under a rearward end of said lower platform to allow said wheels to pivot 360 degrees under said skirt attached to said lower platform,
4) a box like rectangular one piece upper unit comprising dual sides connecting to a lower flat base and connecting on a forward end with a seating shape with a seat with arms and a seat back, with said seat back connecting with an upper flat tray with an opening therein and dual guide handles on a rearward edge of said tray, with said lower flat base connected to said lower platform,
5) a pair of rotatable leg protector and foot rest units with one of each of said pair of units connected in each of a pair of brackets located on each of said sides in front of and adjacent to said bottom end of said seat skirt, each of said brackets having a pin means to rotatably hold each of said pair of leg protector and foot rests with each of said footrests having foot pads angled upward at about 10 degrees and rotatable about 90 degrees to allow said footpads go under said seats and to allow said leg protector to rest against said seat skirt below said seat,
6) a pair of guide handles with one each of said pair of guide handles attached to either side of a rearward end of said upper flat tray,
7) a fail safe brake means and a spring loaded manually depressible lever to actuate said fail safe brake means, said fail safe brake means acting to allow spring loaded brake shoes to immobilize each of said two front wheels if said manually depressible lever is not depressed.

3. A patient carrier as in claim 2 further comprising a round opening in a beginning end of said upper platform to allow carrying a cylinder in an upright position and supported on said lower platform.

4. A patient carrier as in claim 2 further comprising a cylindrical holder in said upper platform to allow removably holding a support for a drip bottle to allow continuous injection to a patient during transport.

5. A patient carrier as in claim 2 wherein a top portion of a pin to fasten said foot rest in said bracket has a cylindrical opening to removably hold a leg rest in a proper in-use position.
